(19) United States
(12) Patent Application Publication
(10) Pub. No.: US 2007/0164205 A1
(43) Pub. Date: Jul. 19, 2007

(54) Method and apparatus for mass spectrometer diagnostics

(76) Inventors: Jean Luc Truche, Los Altos, CA (US); Gregor Overney, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/333,745

(22) Filed: Jan. 17, 2006

(51) Int. Cl. H01J 49/26

(52) U.S. Cl. 250/281; 250/282

(57) ABSTRACT

A mass spectrometer system comprises an internal surface exposed to contamination and an optical sensor assembly positioned so as to monitor a reflection of optical radiation from said internal surface. A method of determining a level of contamination of an internal surface within a mass spectrometer comprises illuminating the internal surface with optical radiation, detecting optical radiation reflected from the internal surface upon illumination, determining a reflectivity value of the internal surface based on the detected optical radiation, and determining the level of contamination based on the reflectivity value.

### FIELD OF THE INVENTION

The present invention relates to mass spectrometry, and more particularly, but without limitation, relates to a method and apparatus for performing diagnostic procedures on mass spectrometers including contamination monitoring.

### BACKGROUND INFORMATION

Mass spectrometers are complex instruments that include numerous internal components. Over repeated use, contaminants, including various chemical and ionic particles, tend to accumulate on the surfaces of many of these components, and form a contamination layer. For example, particles tend to accumulate on skimmers that separate vacuum stages in the spectrometer, and also often accumulate on conductive electrode surfaces. The proper performance of the mass spectrometer depends on the precisely defined electric fields generated by the electrodes. Thus, contamination, which can distort and degrade the electric fields established at the electrode surfaces, affects the uniformity of the electrical fields within the device, and can reduce the overall performance of the mass spectrometer.

To deal with this contamination problem, practitioners typically clean the internal surfaces of the mass spectrometer whenever they realize that performance has degraded to an unacceptable level, or they adopt a cleaning schedule, whereby they clean the internal surfaces of the device once per duration, such as once every six months. In the former case, there is the drawback that by the time it is abundantly clear to the practitioner that the performance has degraded to an unacceptable degree, there has already been a possibly significant reduction in performance. In the latter case, it is sometimes difficult to set the schedule correctly so as to maintain optimal performance of the spectrometer.

In addition, since it is difficult to establish which particular surfaces are contaminated and require cleaning, the mass spectrometer is generally brought up to atmospheric pressure, and given a thorough dismantling and cleaning. Moreover, performance degradation may in some cases be unrelated to surface contamination at all, so that much of the lengthy cleaning procedure may be unnecessary. Thus, if only a particular section(s) is contaminated, much of the manual dismantling and cleaning process would be avoidable if the practitioner could readily determine which surfaces were contaminated to an unacceptable degree.

### SUMMARY OF THE INVENTION

The present invention enables internal monitoring of the contamination of internal surfaces of a mass spectrometer.

In a first aspect, the present invention provides a mass spectrometer system that comprises an internal surface exposed to contamination and an optical sensor assembly positioned so as to monitor a reflection of optical radiation from said internal surface. The internal surface and the optical sensor assembly may be situated within the ion transport section of the mass spectrometer between the ion source and the mass analyzer.

According to one embodiment, the optical sensor assembly comprises an optical sensor element and an illumination element. The optical sensor element may be implemented using an optical mouse sensor.

According to another aspect, the present invention provides a method of determining a level of contamination of an internal surface within a mass spectrometer. The method includes illuminating the internal surface with optical radiation, detecting optical radiation reflected from the internal surface upon illumination, determining a reflectivity value of the internal surface based on the detected optical radiation and determining the level of contamination of the internal surface based on the reflectivity value.

According to a particular embodiment of the method, the determination of the level of contamination includes comparing the reflectivity value to a base value.

According to another embodiment, a notification is activated if a difference between the reflectivity value and the base value is greater than a threshold value.

In yet another aspect, the present invention provides a method of calibrating a mass spectrometer after a cleaning operation, the mass spectrometer including an internal optical sensor assembly for monitoring a contamination of an internal surface within the mass spectrometer, the method comprising: measuring an operating temperature in a vicinity of the internal surface, determining a base reflectivity value of the internal surface at the temperature using the optical sensor assembly, and storing the base reflectivity value.

According to an embodiment, the calibration method further comprises repeating the steps of determining a base reflectivity value and storing this value over a range of temperatures, to obtain a series of base reflectivity values over the entire temperature range.

### BRIEF DESCRIPTION OF THE DRAWINGS

FIG. 1A is a side cross-sectional view of an embodiment of a mass spectrometer that includes functionality for performing internal contamination monitoring according to the present invention.

FIG. 1B is a top elevation of the mass spectrometer of FIG. 1A

FIG. 2 is a cross-sectional view of a mass spectrometer including a time-of-flight (TOF) mass analyzer that includes for performing internal contamination monitoring according to the present invention.

FIG. 3 is a schematic illustration an embodiment of an optical sensor assembly according to the present invention.

FIG. 4 is a flowchart of an embodiment of a contamination monitoring method according to the present invention.

FIG. 5 is a flowchart of an embodiment of a method of calibrating reflectivity values by temperature according to the present invention.

### DETAILED DESCRIPTION

It is initially noted that reference to a singular item herein includes the possibility that there are plural of the same items present. More specifically, as used herein and in the appended claims, the singular forms “a”, “an”, “said” and “the” include plural referents unless the context clearly dictates otherwise.

According to the present invention, internal surfaces of a mass spectrometer that have a tendency to accumulate contamination are monitored using optical sensors. An internal illumination source casts light toward the relevant surfaces which reflect a portion of this light back in the direction of the optical sensors. As a relevant surface accumulates contamination, the amount of light that it reflects changes, and this change is then detected by the optical sensors. A control unit coupled to the optical sensors measures the reflectivity of the surface(s) based on the amount of reflected light received by the optical sensors, and determines whether the reflectivity has moved sufficiently from an absolute or relative threshold. The control unit may activate a notification for the operator to clean and remove contamination from the affected surfaces, or the unit as a whole, if such a determination is made.

It is noted that contamination generally (but not always) results in a decrease in the reflectivity of the internal surfaces, which are usually metallic and reflective. Thus, the description below consistently refers to the changes as decreases. However, this is to simplify the discussion and should not be taken as a limitation since there may be instances in which certain types of contamination can cause an increase in the reflectivity of a particular surface to one or more wavelengths of light.

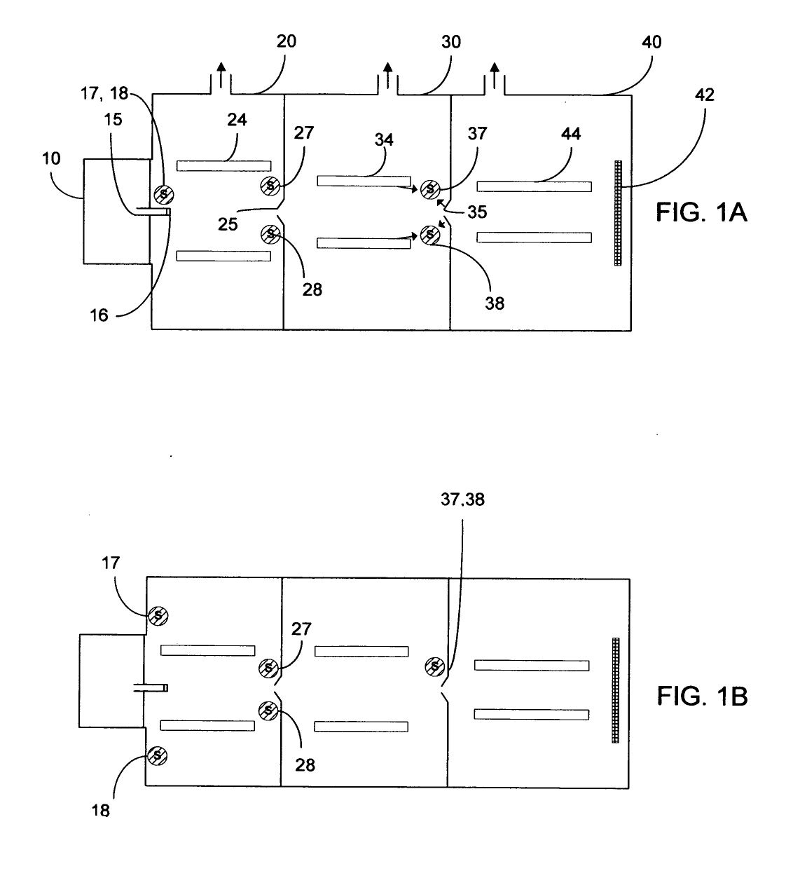

FIG. 1A shows a side cross-sectional view of an embodiment of a mass spectrometer that includes functionality for performing internal contamination monitoring according to the present invention. The mass spectrometer includes an ion source 10 for generating ions from an analyte sample. The ion source may be operated at atmospheric pressure and may include electrospray, atmospheric pressure chemical ionization (APCI), atmospheric pressure photoionization (APPI), atmospheric pressure MALDI (AP-MALDI) or any combination of these ionization mechanisms. Ions generated in the ion source 10 are guided by electrostatic and/or pneumatic means towards a capillary 15 which leads from the ion source to a first vacuum stage 20, which typically is maintained within a pressure range from about 1 mtorr to several torr. The capillary may include an electrode 16 at its downstream end for establishing a potential gradient along its length. Various curtain and/or drying gases (not shown) may be employed in the vicinity of the capillary to remove remaining solvent molecules from the analyte ions.

As shown, the first vacuum stage includes a multipole ion guide 24 (e.g., quadrupole, hexapole, octapole) including conductive rods to which an RF electric potential is applied. As the ions enter the first vacuum stage, they typically undergo a supersonic expansion. The ion guide 24 acts to focus the ions within the first vacuum stage and guide them toward the longitudinal axis of the mass spectrometer. At the downstream end of the first vacuum stage 20 is a skimmer 25 that acts as an interface between the first and second vacuum stages. The skimmer is designed to ‘skim off’ solvents, neutral gases and other particles or chemicals that are superfluous for analytical purposes and can interfere in the mass spectrum of the analyte(s).

Both the electrode end cap of the capillary, because it is electrically active and can attract ionic particles, and the skimmer, because of its physical shape (and also because it too may be chemically or electrically active), can accumulate contaminants on their respective surfaces over time. In accordance with the present invention, optical sensor assemblies (described further below) are positioned in the vicinity of these surfaces to monitor their state. In particular, pairs of optical sensor assemblies 17 and 18 are positioned near the capillary end electrode 16 and optical sensor assemblies 27 and 28 are positioned in the vicinity of the skimmer. The use of pairs of sensor assemblies enables the capture of a three dimensional surface image. For example, the skimmer 25 may be cone-shaped; a sensor assembly placed on one side of the skimmer will generally be able to capture only half of the exposed surface of the skimmer. Thus, as illustrated in conjunction with the top view of the mass spectrometer 1 shown in FIG. 1 B, sensor assembly 17 is positioned on the left side of the capillary electrode 16 (facing downstream) and sensor assembly 18 is positioned to the right side. In this manner, accumulation on either side of the capillary electrode is visible to at least one of the sensor assemblies. For similar purposes, sensor assemblies 27 and 28 are positioned to the upper-left and lower-right of the skimmer, respectively. It is emphasized however, that the actual placement and arrangement of the optical sensor assemblies is exemplary and it is expected that the number of sensor assemblies employed and their positioning will vary depending on the configuration of the device, the degree of contamination expected, and the reflectivity of the internal surfaces, among other potential factors as will be discussed below. It is also expected that these factors may be determined by the skilled practitioner on a trial and error basis based on knowledge of the actual operation of the device in question.

Ions in the first vacuum stage 20 are guided through skimmer 35 into a second vacuum stage 30 maintained at a lower pressure than the first vacuum stage. The pressure in the second vacuum stage may vary between 1 mtorr and 10^{-o} torr, for example. Another RF multipole ion guide 34 positioned within the second vacuum stage further focuses the ions toward the longitudinal access while neutral gases are pumped away. At the downstream end of the second vacuum stage is a second skimmer 35 that blocks out extraneous material and passes the analyte ions into the mass analyzer 40 of the mass spectrometer. As shown in FIGS. 1A and 1B, optical sensor assemblies 37, 38 are included to monitor the contamination condition of skimmer 35, and they are positioned on the upper left and upper right of the skimmer to obtain a complete view of its surface.

Ions that exit through the skimmer 35 in the second vacuum stage 30 enter the mass analyzer where they are scanned and selected according to their various mass-to-charge (m/z) ratios. The mass analyzer may comprise a quadrupole, triple quadrupole, linear ion trap, three-dimensional ion trap, time-of-flight, orbitrap, FT-ICR (Fourier transform ion cyclotron resonance), any combinations of the above, and/or other mass-to-charge analyzers known in the art. Each mass analyzer may have specific internal surfaces heavily exposed to contamination for which internal monitoring according to the present invention would be advantageous.

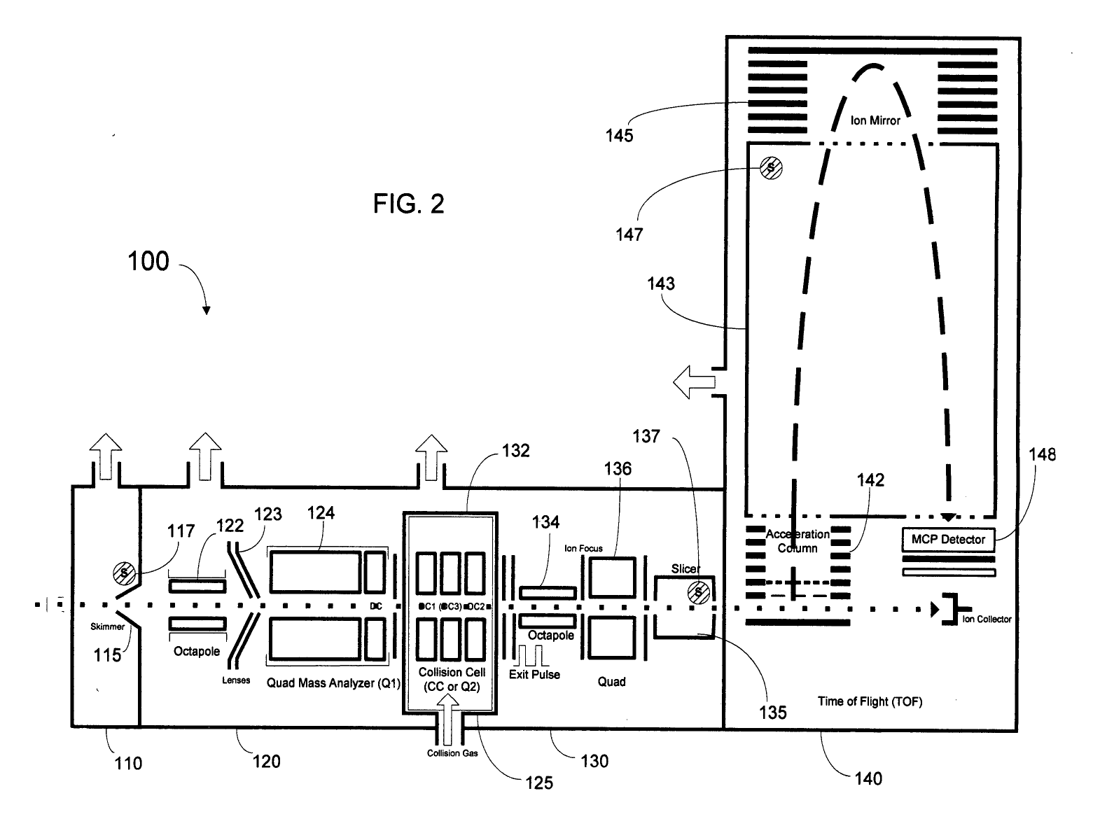

As an example, FIG. 2 illustrates an embodiment of a tandem mass spectrometer 100 (a quadrupole/time-of-flight or ‘q-TOF’) that includes a time-of-flight (TOF) mass analyzer and also incorporates optical sensor assemblies at particularly suitable positions within the instrument. As shown, the tandem mass spectrometer 100 includes an ion source 110 having a skimmer 115 at the downstream end for filtering the introduction of ions into the vacuum stages of the mass spectrometer. An optical sensor assembly 117 is positioned in the vicinity of the skimmer 115 to monitor its state of contamination. In a first vacuum stage 120, analyte ions are guided through an octapole 122, ion lenses 123 and a first mass analyzer 124. Ions that are not eliminated in the first mass analyzer 124 pass into a second vacuum stage 130 via an aperture. The second vacuum stage 130 includes, in sequence, a collision cell 132, in which analyte ions may be fragmented into smaller ions and neutral particles, an octapole ion guide 134 and a further quadrupole ion guide 136 maintained at a dc voltage.

The product ions output from the collision cell are guided through the octapole 134 and quadrupole ion guide 136 into a slicer interface 135 that is used to block ions having a high degree of transverse displacement (displacement in the direction of the flight tube), before the entrance to the to an orthogonal acceleration chamber of the TOF mass analyzer 140. The ions blocked by the slicer 135 accumulate on its surface. Too much accumulation can have an undesirable effect on the local electrical field at the slicer. Thus, an optical sensor assembly 137 is positioned to monitor the upstream surface of the slicer 135 that is exposed to contamination.

Ions that pass through the slicer 135 enter an ion pulser 142 having a back plate and an acceleration column. To start the ion's flight through the flight tube 143, a high voltage pulse is applied to the back plate that accelerates ions through a stack of plate in the acceleration column. The ions then travel through the flight tube in a ‘downstream’ direction toward an electrostatic ion mirror 145. The ion mirror 145 reverses the flow of ions back in the ‘upstream’ direction of the flight tube. The internal and external surfaces of the ion mirror may be particularly exposed to contamination so this is also an area where optical monitoring may be advantageous. For this purpose, an optical sensor assembly 147 is positioned near the entrance of the ion mirror 145 with a view of some of external and internal surfaces of the ion mirror. The ions reversed by the ion mirror flow toward a detector 148, which registers the impact of ions and their flight times through the flight tube 143.

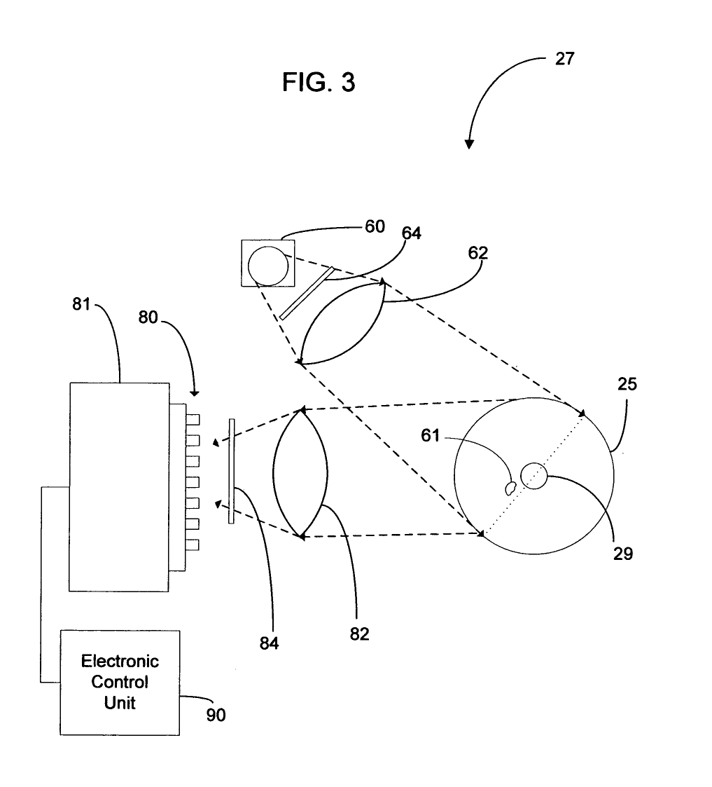

A more detailed description of an embodiment of an optical sensor assembly that may be used in the context of the present invention is given in conjunction with the illustration of FIG. 3.

FIG. 3 shows an example illustration of one of the optical sensor assemblies used in the mass spectrometer of FIGS. 1A and 1B. The optical sensor assembly, e.g., 27, is positioned in the vicinity of skimmer 25. As shown, the optical sensor assembly 27 includes an illumination device 60, which may comprise, for example, a light emitting diode (LED), and an optical sensor device 80, which may comprise an optical mouse sensor. Such optical mouse sensors are described in U.S. Pat. No. 5,686,720 to Gordon et al., for example.

The illumination device 60 is positioned near enough to the monitored object (in the case skimmer 25) such that it can illuminate the surface of the monitored object with sufficient intensity and cover as much of the surface in question as possible. The illumination device 60 may be aided in purpose by including a lens 62 which collimates the light emitted from the LED, and provides more uniform illumination over the surface of the skimmer (the illuminated portion of which is indicated by a dotted line). Also a chromatic filter 64 may be used to pass through monochromatic light of a single color. It is noted in this context that although the term color is used, the LED may also emit light outside the visible spectrum such as infrared or ultraviolet radiation. The wavelength of light used to illuminate the monitored object is selected for maximal reflectivity and contrast. The use of monochromatic light may be preferable in some applications because it may be easier to detect subtle changes in reflectvity when a single wavelength is employed.

The illuminated object reflects light based on its material properties of reflectivity, the internal temperature in its vicinity, and its level of surface contamination. The effects of temperature are accounted for by keeping the temperature close to constant (as in certain time-of-flight applications) or by calibrating the reflectivity readings to a base level for a particular temperature. This calibration process is discussed in greater detail below. At this point, it is merely noted that the effects of temperature can be removed from consideration so that changes in reflectivity can be attributed solely to contamination. As shown in FIG. 3, near the central orifice 29 of the skimmer 25, there is a localized region where a detectable level of contamination has accumulated 61.

The optical sensor, which as noted, can include elements used in optical mouse sensors, includes a one or two-dimensional array of optically sensitive elements 80 coupled to a substrate 81. The array may be charge-coupled devices (CCD), an amorphous silicon photodiode array, or any other type of one or two-dimensional array sensor known in the art. The spacing of the elements determines the resolution of the monitoring process. Thus, the number of elements in the array is selected to achieve the desired resolution, e.g., 300 dots per inch (dpi) for monitoring purposes. A portion of light cast from the illumination device 60 and reflected from the illuminated surface of the skimmer 25 is directed toward the optical sensor 80. At least one, and preferably more than one element of the sensor array, may receive light reflected from the contaminated region 61 of the skimmer 25, and register a change in reflected light intensity indicative of the presence of contamination. An electronic control unit 90 coupled to the optical sensor then determines a reflectivity value based on signals received from the optical sensor 80.

A lens element 82 and a chromatic filter element 84 may be positioned between the skimmer 25 and the optical sensor 80 to further ensure that the light captured by the sensor consists substantially of light of the selected wavelength which aids in the analysis. The lens element 82 focuses the light directly towards the optically-sensitive array elements of the sensor 80.

It is noted that the exact positioning of the illumination device 60 and optical sensor 80 elements with respect to the skimmer 25, depends to some extent on the intensity of illumination and the sensitivity of the array elements. The greater the intensity and sensitivity, the further away from the skimmer these elements can be positioned, allowing a fair amount of flexibility in implementation.

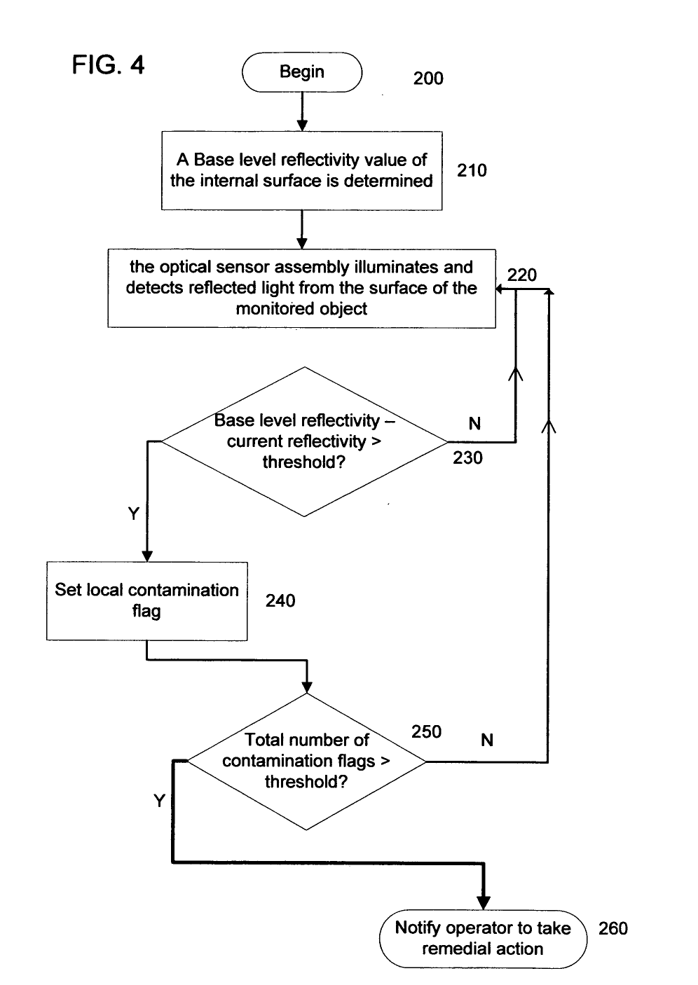

A flow chart of an embodiment of an exemplary contamination monitoring and detection process according to the present invention is shown in FIG. 4. At the commencement of the monitoring (200), the mass spectrometer instrument is cleaned, and it is assumed that the level of contamination on the internal surfaces of the device is low. For a particular internal surface, a reflectivity value is determined at this point (210) that serves as a base level to which later readings may be compared. During operation of the mass spectrometer, the optical sensor assembly monitoring the surface continually illuminates the internal surfaces of the monitored instrument components and detects reflected light (220). Over a duration of spectrometer operation, contamination accumulates on the surfaces and the optical sensors pick up changes in the reflectivity on portions of the devices. When the change in reflectivity from the base level reaches a threshold level (230), a contamination flag may be set indicating that an unacceptable level of contamination has been reached (240). If the threshold has not been reached, the process cycles back and monitoring continues.

If only a small number of array elements exposed to light from the monitored device register a change in reflectivity indicative of an unacceptable level of contamination, i.e., if only a small number of contamination flags have been set, this probably indicates that only a small portion of the surface of the device is contaminated. It might not be feasible to stop operation and clean the device based on only a small amount of contamination. Therefore, it is useful to preset a total contamination level threshold, or threshold flag number, as a measure of a total level of contaminated regions that is considered unacceptable. Thus, after it is determined whether a change in reflectivity has reached the threshold level, a further determination is made as to whether the total contamination threshold has been reached (250). When this threshold is reached, a notification may be actuated indicating that a total contamination of a monitored device has reached unacceptable levels, and that some remedial action may be necessary (260).

It is also possible to use pattern recognition in the context of the present invention whereby the electronic control unit includes pattern recognition software and responds when an overall pattern of light/dark or reflectivity values varies from a reference pattern, indicating an unacceptable level of contamination.

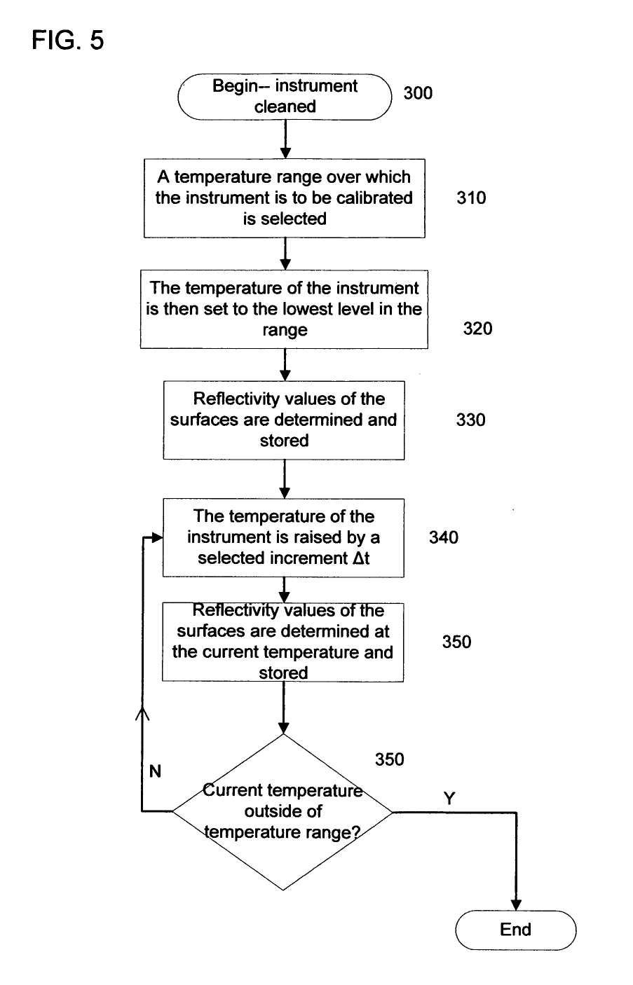

As noted above, the base level reflectivity of an internal surface in a mass spectrometer typically varies to some extent with temperature. For mass spectrometer instruments that experience large temperature fluctuations, it is important to obtain a series of base level reflectivity values over a pertinent temperature range to calibrate the reflectivity values at any given temperature. FIG. 5 shows an exemplary flow chart of a temperature calibration method according to the present invention. At the commencement of the method the mass spectrometer instrument is cleaned to remove as much prior contamination as possible (300). A temperature range over which the instrument is to be calibrated is then selected (310). The temperature of the instrument is then set to the lowest level in the range (320), and reflectivity values for the pertinent internal surfaces of the instrument are determined and stored (330). The temperature of the instrument is then raised by a selected increment Δt (340) and reflectivity values are determined at this current temperature and stored (350). A check is then performed to ascertain whether the incremental increase in temperature raises the temperature out of the selected temperature range (360). If it does not, the process cycles back to step (340); if, on the other hand, the raised temperature is beyond the range, the process ends (370). In this manner, base level reflectivity values are obtained for the entire selected temperature range. These base values are stored and accessed so that the base level corresponding to the current temperature of the mass spectrometer can be used during the contamination monitoring process.

Having described the present invention with regard to specific embodiments, it is to be understood that the description is not meant to be limiting since further modifications and variations may be apparent or may suggest themselves to those skilled in the art. It is intended that the present invention cover all such modifications and variations as fall within the scope of the appended claims.

What is claimed is:

1. A mass spectrometer system comprising:
an internal surface exposed to contamination; and
an optical sensor assembly positioned so as to monitor a reflection of optical radiation from said internal surface.

2. The mass spectrometer system of claim 1, wherein the mass spectrometer system includes an ion transport section and the internal surface and the optical sensor assembly are situated within the ion transport section.

3. The mass spectrometer system of claim 1, wherein the mass spectrometer system includes a mass analyzer section and the internal surface and the optical sensor assembly are situated within the mass analyzer section.

4. The mass spectrometer system of claim 3, wherein the mass analyzer section comprises a time-of-flight (TOF) mass analyzer.

5. The mass spectrometer system of claim 4, further comprising:
a slicer having a surface;
wherein the internal surface exposed to contamination includes the surface of the slicer.

6. The mass spectrometer system of claim 4, further comprising:
an ion mirror having a surface;
wherein the internal surface exposed to contamination includes the surface of the ion mirror.

7. The mass spectrometer system of claim 1, further comprising:
an electrode having a surface;
wherein the internal surface exposed to contamination includes the surface of the electrode.

8. The mass spectrometer system of claim 1, further comprising:
a skimmer having a cone-shaped surface,
wherein the internal surface exposed to contamination includes the cone-shaped surface of the skimmer.

9. The mass spectrometer system of claim 1, wherein the optical sensor assembly comprises an optical sensor element and an illumination element.

10. The mass spectrometer of claim 9, wherein the optical sensor element comprises an optical mouse sensor.

11. The mass spectrometer system of claim 9, wherein the optical sensor assembly further includes a first lens element positioned adjacent to the illumination element and a second lens element positioned adjacent to the optical sensor element.

12. The mass spectrometer system of claim 11, wherein the optical sensor assembly further includes a first monochromatic filter element positioned adjacent to the illumination element and a second monochromatic filter element positioned adjacent to the optical sensor element

13. The mass spectrometer system of claim 9 further comprising an electronic control unit coupled to the optical sensor element, the electronic control unit being configured to determine a measurement of a reflectivity of the internal surface exposed to contamination based on a signal received from the optical sensor.

14. A method of determining a level of contamination of an internal surface within a mass spectrometer, the method comprising:
illuminating the internal surface with optical radiation;
detecting optical radiation reflected from the internal surface upon illumination;
determining a reflectivity value of the internal surface based on the detected optical radiation; and
determining the level of contamination based on the reflectivity value.

15. The method of claim 14, wherein determining the level of contamination includes comparing the reflectivity value to a base value.

16. The method of claim 15, further comprising:
activating a notification if a difference between the reflectivity value and the base value is greater than a threshold value.

17. The method of claim 14, wherein the optical radiation used to illuminate the internal surface is monochromatic.

18. The method of claim 14, further comprising:
calibrating the base value as a function of an operating temperature of the mass spectrometer.

19. The method of claim 13, wherein detecting the optical radiation comprises using an optical mouse sensor.

20. A method of calibrating a mass spectrometer after a cleaning operation, the mass spectrometer including an internal optical sensor assembly for monitoring a contamination of an internal surface within the mass spectrometer, the method comprising:
a) measuring an operating temperature in a vicinity of the internal surface;
b) determining a base reflectivity value of the internal surface at the temperature using the optical sensor assembly; and
c) storing the base reflectivity value.

21. The method of claim 20, further comprising:
d) increasing the operating temperature by an incremental amount; e) repeating steps b) and c) at the increased temperature; and
repeating step d) and step e) until reflectivity values for a full range of temperature values has been stored.

22. A method of determining a level of contamination of an internal surface within a mass spectrometer, the method comprising:
illuminating the internal surface with optical radiation;
detecting optical radiation reflected from the internal surface upon illumination;
obtaining a multi-dimensional pattern from the detected light;
comparing the multi-dimensional pattern of the detected light to a reference pattern; and
determining the level of contamination based on the comparison of the multi-dimensional pattern of detected light and the reference pattern.
